(19) United States
(12) Patent Application Publication
(10) Pub. No.: US 2006/0126826 A1
(43) Pub. Date: Jun. 15, 2006

(54) Apparatus and method of encoding and decoding information

(76) Inventors: Carlos Alberto Rega, Doritwich (GB); Christopher James Lloyd, Hyde (GB); David John Clarke, Cheshire (GB)

Correspondence Address: Thomas E Thompkins Jr;Iandiorio & Teska, 260 Bear Hill Road, Waltham, MA, 02451, US

(21) Appl. No.: 10/530,935

(22) PCT Filed: Oct. 10, 2003
(86) PCT No.: PCT/GB03/04401

§ 371 Date: Nov. 23, 2005

(30) Foreign Application Priority Data
Oct. 11, 2002 (GB) 0223692.5

(51) Int. Cl. H04L 9/28; H04L 9/00; H04K 1/00

(52) U.S. Cl. 380/28

(57) ABSTRACT

A method for encoding and decoding information, the method comprising the steps of: (a) using at least one mathematical function; (b) producing an encryption algorithm using the mathematical functions such that the algorithm has at least two parameters; (c) defining a decode key of a data stream by defining the value of at least one parameter; (d) defining information to be carried in a data stream by defining the value of at least one parameter; (e) producing a data stream using the encryption algorithm and the defined parameter values; and (f) decrypting the data stream where the decode key is known and used as a constraint in the equation such that the information in available, wherein the encryption algorithm is selected such that decoding of the encryption algorithm would be ill-conditioned without the constraint.

### FIELD OF THE INVENTION

This invention relates to apparatus and method of encoding and decoding information.

### BACKGROUND OF THE INVENTION

There are numerous methods of authentication in which a user encrypts a password, number, or message within a transmission in a manner that only the assigned reader can access.

The ability to prove that a message originated from a specific source over an unsecure network means has significant commercial advantage in allowing transfer of information that may otherwise require some form of specialised delivery and/or delivery media leading to extra cost and/or delay in transfer. Such transfers become more important with the increase of on-line banking means and purchasing. In many cases the security relies on a simple password, which if made public, allows any person to appear to be the rightful password owner. In authentication methods single pad methods are beneficial in that the same password is only used once in some form of sequence. However, if the method is properly understood then the sequence may be predetermined.

In many cases the method of security and methods of cracking rely on random number generation. It is known in the art that the random number generator based on a mathematical code is not random but predominantly non-random to a specific number of values. If too many numbers are required such that the random number cycles or if a fault in the generator is known by the hacker such that no-randomness occurs earlier then this aids methods of hacking

If the password is cracked or obtained by other means then the system ceases to be secure.

For reasonable security the passwords require to be large, frequently 128 bits or greater and a random sequence should be chosen. The inability of the user to remember such a random sequence frequently requires the user stores password, which may defeat security. When a user selects his own random number the number is typically not random which may defeat security. When the user selects a random number by a computer means the number typically not random which may defeat security

In addition the user may use the password a multitude of times. reuse of the same password means that it is easier to crack the password using open text attack methods. In addition if a hacker obtains said password then all documents encrypted with it may be opened.

The rise in methods to stop de-encryption tend to rely on increasing the effective password length to many bits. In most cases this does not make breaking the password harder but simply more time-consuming and a large supercomputer or a network of smaller personal computers (PC's) will eventually breach the code. A limit on password technology is that when the code is known, then it is obvious when the password has been found because the encrypted article changes from meaningless random data to a recognisable format.

One limitation of all security methods is that they must operate at the required speed on the computers they are designed for and thus typically an encode/decode process must be made with seconds to minutes such that the product may be usable. However when the algorithm are loaded on a large computer many guesses may be made allowing brute force attacks to open even random codes in reasonable times if the code length is not of a significant size.

One limitation of a security system is that to guess one value of a password and takes the same time as inputting the correct answer and this compounds the problem of larger processors being able to break passwords by brute force guessing.

One limitation of many secure systems is that the means of encryption must be transferred in a secure way and that where software is used the source code must be kept secret as this may allow breach of the method. It is known in the art that compiled code can be reverse engineered thus allowing a means of breaching such systems.

One limitation of security systems used to transmit between two nodes is that algorithms that are unstable or chaotic allow a secure means of encryption but may be liable to encrypt messages in a way that cannot be decrypted, limiting the available security to deterministic algorithms which may have weaker security.

One limitation of security systems is that they use deterministic algorithms may be cracked such that all documents encrypted by the method, even where different passwords are used, and insecure.

One limitation of security systems is that their reliance on a pseudo-random number stream means that encrypting a file with a second encryption means after it has been encrypted by a first encryption means may make the overall encryption weaker and conventional encryption cannot always be ‘stacked’ to add security.

One limitation of security systems when used to transmit between two nodes where passwords are used a plurality of times is that a hacker may simply eves-drop on a communication and collect authentication message and codes for later use such that time and expense must be consumed in ensuring a secure line of transmission.

One limitation of security systems where a host communicates with a plurality of nodes and must transmit similar information to each node is that even where each node has an individual password the releasing of the same message using multiple passwords that occurs reduces the security of the method.

One limitation of security systems is that passwords should be chosen at random humans are not good at the selection of random numbers.

One limitation of a security system is that passwords should be different between each pair of transmitter/receivers and should alter randomly and differently for each transmission and humans are not good of keeping track and keeping secure large numbers of long random sequences and methods to alter them.

One limitation of a security system is that a trusted host must be used to transfer passwords between users and that this is a security breach in that the server may retain a memory of the passwords.

One limitation of a security system is that a trusted host must be used to transfer passwords and nodes cannot often cannot define a host trusted by both between them and such a network is liable to attack by attack of the servers as the system is not a distributed network.

One limitation of conventional encryption means is that stacking different encryption methods may not increase security and may decrease security.

One limitation of a password system is that the locked system must have knowledge of password such that it may authenticate the correct password and that this knowledge is a security breach as the system may be de-engineered or hacked and the correct password found.

One limitation of conventional locks is that a lock has a specific key and where the lock is physical and must open a physical device the supply chain allows security breach. Such a breach may be costly as multiple physical locks may require to be replaced and product recalls may be required. Such a breach may also be costly as faith may be lost in the product. Loss of faith in the product may be costly directly or indirectly. An example of indirect may be increased insurance premium for a car reducing sales of said vehicle.

One limitation of conventional locks is that when a key has been given out it is not possible to guarantee it will be returned or returned uncopied and this increases the risk and thus cost of hiring items requiring locks.

One limitation of a system based on a server or host is that the host may be jammed directly or by distributed denial of service methods.

It is an aim of the present invention to obviate or reduce the above mentioned problems.

### SUMMARY OF THE INVENTION

According to one non-limiting embodiment of the present invention, there is provided a method for encoding and decoding information, the method comprising the steps of:
(a) using at least one mathematical function;
(b) producing an encryption algorithm using the mathematical functions such that the algorithm has at least two parameters;
(c) defining a decode key of a data stream by defining the value of at least one parameter;
(d) defining information to be carried in a data stream by defining the value of at least one parameter;
(e) producing a data stream using the encryption algorithm and the defined parameter values; and
(f) decrypting the data stream where the decode key is known and used as a constraint in the equation such that the information is available,
   wherein the encryption algorithm is selected such that decoding of the encryption algorithm would be ill-conditioned without the constraint.

The method may include the step of selecting at least one function that is not periodic.

The methods may include the formation of a system which encrypts information where the time taken to trail a single guess by a hacker is significantly longer than the time taken to validate the correct decode key.

This produces a method where without the key there are infinite or near infinite number of possible parameter value sets that mathematically have a fit as good as the set defined by the decode key.

The solutions found by hacking could in some instances be close to the correct answer which would limit security but the method can include the step of reducing the accuracy of the representation of the data stream.

The accuracy of representation may be reduced using truncation of the data stream values. The accuracy of representation can be reduced using rounding of the data stream values. The accuracy of representation can be reduced by the inclusion of noise in the data stream values.

The accuracy of representation of the data stream may made such that decoding the signal without the decode key given both an ill-condition and non-convergent problem. Solution sets of parameters found without the decode key may appear chaotic with multiple solutions that appear well fitting being a significantly different in form. The solution set that is best fitting by mathematical measures, without using the decode key, will not be the correct solution as defined by the decode key thus producing a more secure system.

The method may be such that an analysis may be non-convergent where only the decode key is unknown.

The method may be such that analysis may be non-convergent when both the form of the encryption algorithm and the decode key are unknown.

Producing a data stream that is non-convergent for analysis without the decode key may lead to a significant probability that the analysis is non-convergent even with the decode key and thus data streams produced that cannot be unencrypted even with the decode key. The method may include a step of decrypting every data stream immediately after it has been formed and where decryption cannot occur repeating the method with at least one new or changed encryption parameter until a data stream that can be decrypted using the decrypt key has been produced.

The accuracy of representation may be reduced such that on average less than 1% of all data streams produced cannot be decrypted. The accuracy of representation may be reduced such that on average more than 10 percent of all data streams produced cannot be decrypted. The accuracy of representation may be reduced such that on average more than 50% of all data streams produced cannot be decrypted. Altering the probability of variable decryption affects the security of the method as well as the time taken to form a new data stream. The method may allow the probability of viable decryption to be modified by a user.

The method can include the additional step of sending the encoded data over a communication link.

The method can include the step of storing the encoded data in a storage medium.

The information can include a password. The password may operate on an external system. The external systems can be of any type and include but are not limited to a file decrypted by the password, an area and the password allows access equipment and the password allow operation, a financial account and the password authorise movement of monies, a piece of software and the password may allow its use, a product and the password allow access to viewing or ownership of the product. Products may include but are not limited to music, spoken word, films, entertainment broadcasts, written works, works written in musical score. The external system may include but is not limited to a website and the password allow access to read or change the website or values held by the website, a communication device and the password allows communication, an authorisation device and the password defines that authorisation occurs. The authorisation may be for credit, the authorisation may for debit transactions. The external system may include but is not limited to identification of an individual article to validate it is genuine or has been subject to the correct processes. The identification could include a means of a password or identify card, a means of ensuring inspection or test of a product, device or vehicle has occurred, a means of ensuring a tax has been paid, or ownership of an object. The external system may include but is not limited to a ticketing device, a security system and the password to allow movement or access whilst overriding a means of security.

The card may include the storage of tokens of value that have become the property of the card holder due to purchase made by means of the invention.

The information can include an authentication information and the method can include the further step of authenticating the encoded data using the authentication parameters.

Authentication means involving the transmission or storage of information which defines the producer in a manner that the information cannot easily be copied and thus authentication may be considered encryption where the information stored is authentication information.

The information can include encryption mutation information and the method can include the step of using the mutation information to alter the encryption method in a defined manner.

The method may include a mutation key.

The method may include selection of a mutation key by random means.

The mutation key may be made to act on the form of the ordinate values used to create a data stream.

The mutation key may affect one or more of the mathematical functions used in the encryption algorithm.

The mutation key may effect the number of mathematical functions used in the encryption algorithm.

The mutation key may affect the type of mathematical functions used in the encryption algorithm.

The information may contain authentication mutation information and the method can include the step of using the mutation information to alter the authentication parameters in a defined manner.

The method may be supplied in unprotected means as knowledge of the implementation does not breach the method. This is advantageous as it allows the method to be supplied as library functions to be built into larger works without security issues. This is advantageous as it allows source code to be distributed such that users can validate the software without security issues.

The method may include a one-way encryption means using encryption other than that described by the invention and include the step of using said encryption on information stored by a sender to authenticate the next received transmissions.

The method may include numerous stored decode keys for each communication link such that if communication is lost then the user may reestablish communication with the next decode key in the list.

The method may use a protocol that ensures the stored password list is always updated such that when a communication has been broken the first data transmissions following authentication are new passwords for future communication failure.

The method may use an algorithm that requires the release of stored passwords due to a communication break to be limited. One method of limiting is to wait an interval following release of each password. A second method of limiting is to wait an interval following the release of each password where the interval is increased on each release. A third method of limiting release of the algorithm is where a secondary communication between nodes is required to check the communication break was not malicious.

The method may include a step of giving each node a registration number that may be public and a first decode sequence that is stored by the node and is specific to the registration number known only to a host and the node such that the nodes first communication is with a host by means of unencrypted means defining the registration number and then the host contacts the node by encrypted means using the first decode key and thus secure communication is established.

Preferably the values of the parameters of the first decode key are unrelated to the values used in the registration number. The system may be distributed with multiple first decode keys for a number of different hosts.

The method may include the step of distributing nodes which have a stored first decode which is known to a host such that a host may initiate secure transmissions following distribution of the nodes.

The method may include a double handshake means. The double handshake means nay be defined to ensure two way authentication over an unsecured line such that evesdropping does not allow impersonation.

The method may include a step of allowing a first node to contact a host and make a request for decode key be established between the first node and a second node and the host enables a first decode for the two nodes nodes by secure means.

The method may allow a node to act as a host between two further nodes to initiate a first decode key between the latter two nodes and so provides a distributed start-up means.

The method may include an implementation such that when a node acts as a host to initiate a decode key between two further nodes it does not make available to decode key to the user of the first node and so provide a secured distributed start up means.

The implementation may be such that when a first node acts as a host to initiate a decode key between two further nodes the first node ensures the decode key is not stored on the processor or memory of the first node and so provide a secure distributed start up means.

The implementation may include a second or more registration numbers that are unique to each node and remains fixed and is used to code information between nodes in manner that the node user has no access to this information and so provide a secure start up means.

The method may include the step of encrypting the parameter values by conventional encryption before they are used in the encryption algorithm.

The method may include the step of encrypting the data stream by conventional encryption before the data stream is transmitted or stored.

The method may include a means where the storage areas used to hold at least some of the parameters that form the authentication key are stored in the same substrate as the processor that performs the encryption.

The method may include a means of flushing or overwriting temporary data areas used in formation of a key.

The method may include the step of using conventional encryption stacked with the invention to give greater security.

The method may include the step of using a plurality of conventional encryption means stacked with the invention where the invention isolates between the conventional means and ensures greater security.

The method may use a nested mode protocol. The nested mode protocol may first use the invention to authenticate between users. The nested mode protocol may then use a different encryption algorithm to transfer information. The first and second encryption algorithms may differ only in the value of keys. The first and second encryption algorithms may vary in the form of the encryption algorithms and contain a different number or type of mathematical function.

### BRIEF DESCRIPTION OF THE DRAWINGS

Embodiments of the invention will now be described solely by way of example and with reference to the accompanying drawings in which:

FIG. 1 shows a method according to the present invention for encoding and decoding information;

FIG. 2 shows a public key cryptosystem;

FIG. 3 shows a rounding process;

FIG. 4 shows a truncation process;

FIG. 5 shows noise added to encoded data;

FIG. 6 shows a communication link;

FIG. 7 shows a system comprising a computer;

FIG. 8 shows an authentication marker;

FIG. 9 shows a public key cryptosystem;

FIG. 10 shows a convergent process and a non convergent process;

FIG. 11 shows an identification device;

FIG. 12 shows that password mutation resists open text attacks;

FIG. 13 shows a node initiating communication with a host;

FIG. 14 shows that initialisation of communication between two nodes using a host does not breach security;

FIG. 15 shows using a node to initialise communication between two nodes using a third trusted node does not breach security;

FIG. 16 shows a secure apparatus for encoding and decoding;

FIG. 17 shows the use of one way encryption to secure authentication keys between transmissions;

FIG. 18 shows that parameters may be defined in the spacing of the ordinates used in the encryption algorithm to provide the data stream;

FIG. 19 shows how the method allows conventional encryption mechanims to be sandwiched;

FIG. 20 shows how conventional encryption of the parameters before production of the data stream gives added advantage;

FIG. 21 shows a means of operating an external system according to invention where the external system is exemplified as a car security system;

FIG. 22 shows an exemplification of a double handshake protocol and an exemplification of a nested system and exemplification of password mutation;

FIG. 23 shows some of the mathematical functions that may be used in the invention;

FIG. 24 shows how use a baseline may be used as a parameters of an encryption algorithm;

FIG. 25 shows a distributed network map;

FIG. 26 shows the complexities of hacking the invention even where the form and number of mathematical functions used in the encryption algorithm are known to the hacker;

FIG. 27 shows the complexities of hacking the invention even where the form of mathematical functions used in the encryption algorithm are known to the hacker; and

FIG. 28 shows the complexities of hacking the invention.

### DETAILED DESCRIPTION OF PREFERRED EMBODIMENTS OF THE INVENTION

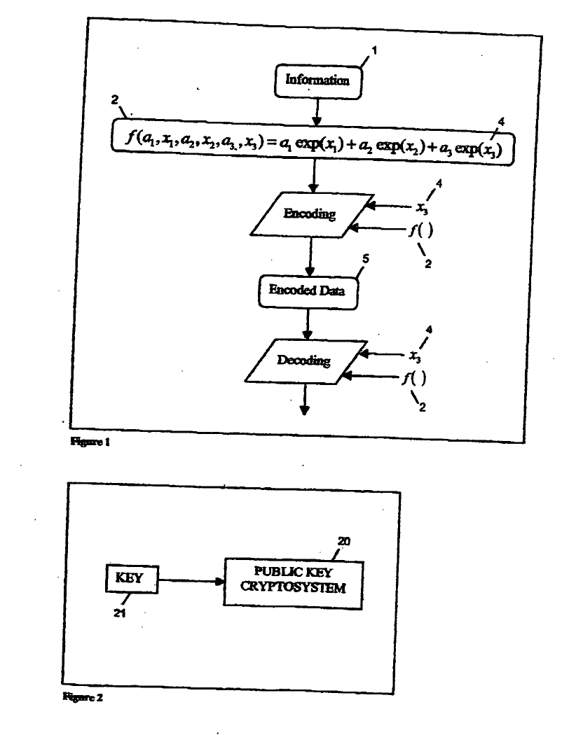

FIG. 1 shows a method for encoding and decoding information 1, the method comprising the steps of selecting a mathematical function 2 having at least one parameter 3, constraining the equation produced using the mathematical function 2 by defining a decoding key 4 as the value of at least one parameters 3 of the function 2, generating encoded data 5 using the mathematical function 2 according to the information 1 and the decoding key 4, decoding the encoded data 5 using the decoding key 4 to constrain the mathematical function 2, wherein decoding of the mathematical function 2 would be ill-conditioned without the constraint. The mathematical function may be selected to be non periodic as this limits hacking by means of conventional signal analysis. Methods of signal analysis include Fourier transform and correlation techniques

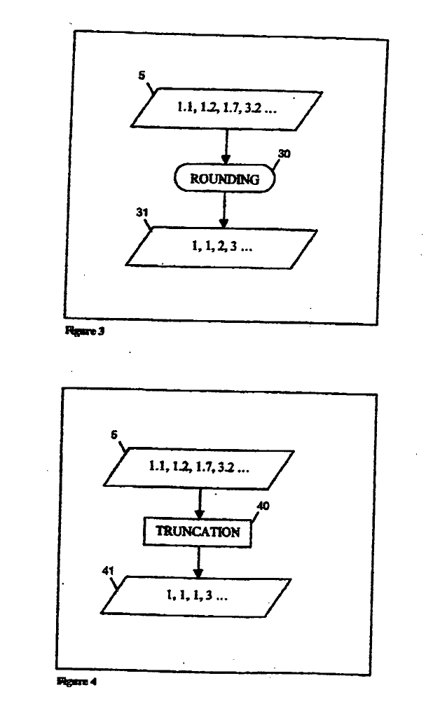

FIG. 2 shows a public key cryptosystem 20 that utilizes at least one key 21 to encode and decode data. The key 21 can be contained in the information 1 that is encoded and decoded using the method of FIG. 1. The public key cryptosystem 20 can be the Diffe-Hellman public key cryptosystem.

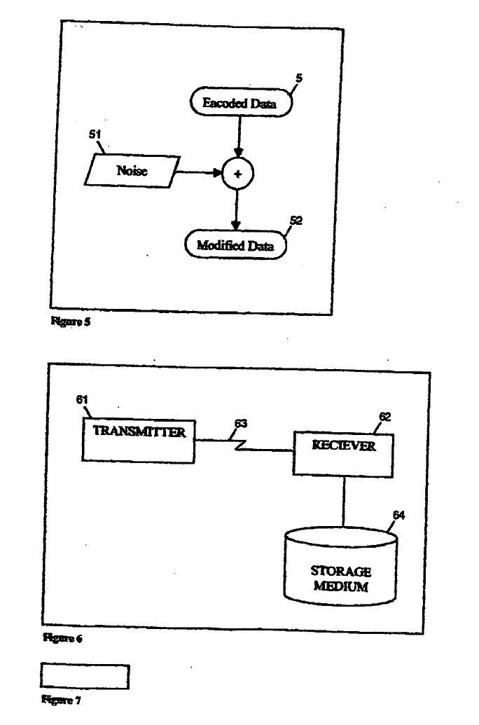

As shown in FIG. 3, the method can include the step of reducing the precision of the encoded data 5by rounding 30 to yield rounded data 31. Alternatively, or additionally, the precision can be reduced using truncation 40 to yield truncated data 41 as shown in FIG. 4.

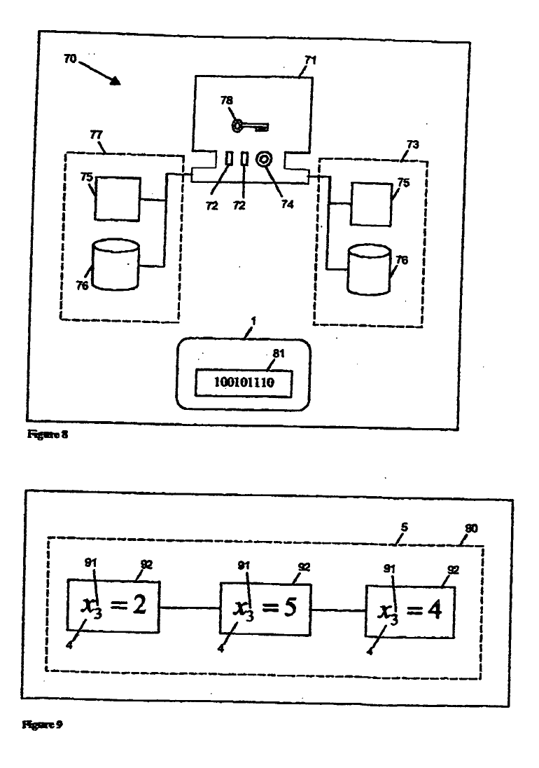

As shown in FIG. 5, the method can include the step of adding noise 51 to the encoded data 5 to yield modified data 52.

FIG. 6 shows an apparatus 60 for encoding and decoding the information 1 comprising a transmitter 61, a receiver 62, a communication link 63, a storage medium 64. The information 1 is encoded in the transmitter 61, the encoded data 5 is sent over the communication link 63 and decoded at the receiver 62. The encoded data 5 can be stored in the storage medium 64.

FIG. 7 shows a system 70 comprising a computer 71, files 72, equipment 73, and software 74. The equipment 73 can promise a printer 75 and data storage 76. The system 70 may include a secure area 77. The information 1 can include a password 78. The password 78 may allow access to the secure area 77. The password 78 may allow usage of the equipment 73. The password 78 may allow usage of the software 74.

FIG. 8 shows an authentication maker 81 that is part of the information 1. The method can include the further step of authenticating the encoded data 5 using the authentication marker 81.

FIG. 9 shows encoded data 90 that includes mutation information 91. In this example the encoded data 5 is separated into different packets 92 and the parameter 4 changes. Variation of the parameter 4 is known by the user to signify a different constraint in the decoding process.

FIG. 10 shows how non convergence may be used to improve security. The trace shows the quality of fit that may be found when a hacker guesses correctly the number and type of mathematical functions used in the security and iterates the parameter value. Where the data is high quality the analysis may be convergent such that the hacker eventually find the correct solution or a close solution (a) where the data quality is reduced slightly the solution may still be convergent but the time taken to find the correct or almost correct solution requires more iterations as the surface has a plateau (b). Where the data quality is even more limited the solution to the hacker becomes ill-conditioned and there appear a plurality of correct solutions (c), even for a fixed number and type of mathematical functions, and the solution is method has increased security.

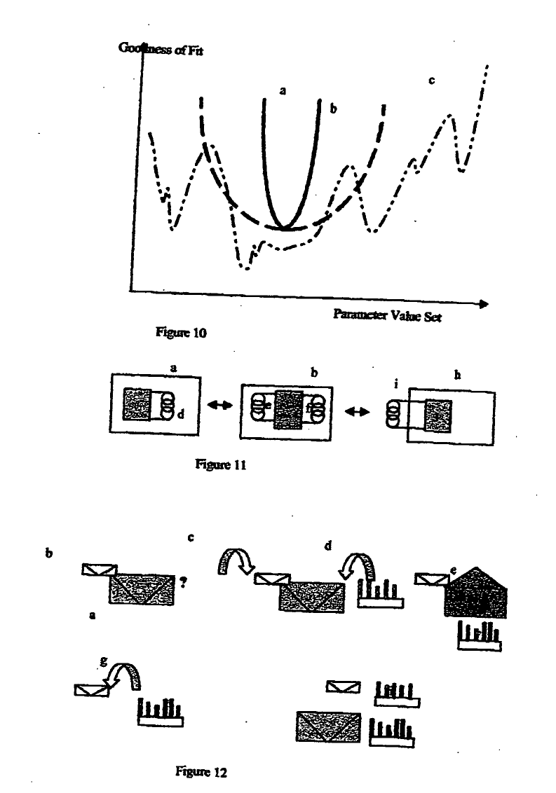

FIG. 11 illustrates how the invention may be used to allow the proof of identity of an individual over unsecured transmissions. The figure uses an example of a financial transaction over a credit card to illustrate the invention and the application does not define a limited use of the invention. A smart card (a) is presented to a reader (b). The card may be a card, clip or be incorporated in clothing or personnel effects or attached to or placed within the body of the individual. The card may be power source may include by a battery, capacitor and a solar panel, The card may include a self winding mechanism powered by movement of the body or directly by the body itself by heat or other means.

The card has a method of encrypting and decrypting the messages according to the invention (c) and a means of communicating with the reader (d). The reader has a means of communicating with the card (e) the host (f) who authorizes financial transactions for the user. The reader is capable of encrypting and decrypting messages according to the invention (g). The host (h) has a means of communication with the reader (i) and a means of encryption (j) according to the invention. The host issues cards to the users with a start sequence that host has stored securely. The host issues readers to the retailer with a different start sequence that the host has stored securely.

The reader reads the public registration number of the card and contacts the host via an encrypted sequence. the host replies to the reader with the correct mutated sequence and requests send of the next sequence by the reader. The host replies and asks for next sequence by the host. Following this the host and retailer have authenticated each other in a manner tat would not allow interception means to allow a hacker to assume the identity of either. The host then passes to the reader the next sequence that is required by the card. The reader does not know the encryption key and simply relays the information to the card. The card authenticates this sequence and sends back the following sequence which reads relays to the host. The host authenticates this sequence and replies and the card replies again. The card and the host have now authenticated themselves via the reader in a secure manner. The host than requests the financial details of expenditure from the reader (retailer) and then transfers this information to the card by means of the invention. The card then displays to the card owner the transaction details that the vendor has requested authorization for. On the reply to this sequence the card authorizes or cancels this expenditure to the host. The host contacts the vendor with the authorization through the reader-host sequence. This ensures that transaction details are fully defined to all the parties prior to authorization limiting fraud by both the vendor and the cardholder and requires no trust and thus security limit be placed in the vendor.

FIG. 11 shows the reader having a separate network for the card and the host (e, f). the network may be a common network. The network to the host may be a multi-hop network which utilizes cards between the reader and the host. The communication method may include electrical signals, optical signal and sonic signals. the electrical signals may be transmitted by cables or wireless means.

The credit card may set up a further separate sequence with the retailer on the first purchase and act as a loyalty card or enable co-branding sales mechanism. This information may be stored securely on the host as described or the on a second host dedicated to this purpose alone. The second host may belong to the retailer or to the financial company.

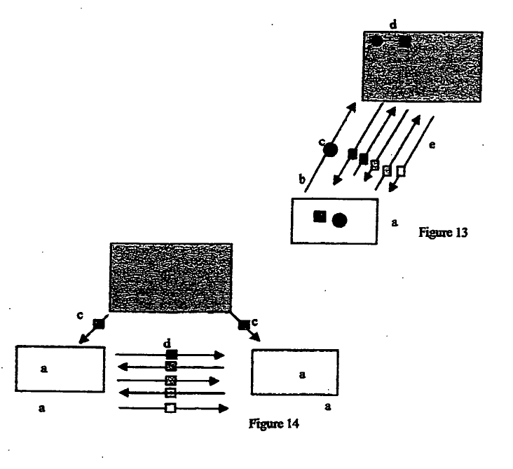

FIG. 12 shows an open text attack used against the invention when the invention is used to securely transfer passwords to attached encrypted messages. The document (a) is encrypted by usual encryption means and the attached second transmission encrypted according to the invention (b) contains information to open the message. The message encrypted according to the invention may be in a separate data file, places in the same data file as the encrypted message or sent by a different network or means.

There is no direct attack that may be applied against the data stream according to the invention (c) as the hacker will constantly find what appears to be correct solutions. The hacker may thus carries out an attack on the attached message (d). In the most basic method known as a brute force attack the hacker attempts to guess every possible combination. If the hack is successful the hacker will be aware of the success as the encrypted file turns into a recognisable file format (e) such as a document file and the hacker is aware he has the correct key (f). The hacker may then attempt a similar process on the message sent according to the invention (g) and attempt to crack the invention, a crack being defined as a hack that not only makes a message insecure but makes the entire method unsecure. With a single data file the hacker could not calculate how the found password had been stored in the parameters but if the hacker collects many hacked documents then he could attempt to find a commonality. Where a mutation key had been properly defined this may take an unfeasible quantity of time and be impractical as many thousands or millions of attached messages may require to be hacked depending on the implementation of the invention. The messages must be a sequence of messages and not randomly due to the mutation of the sequence.

Where a password mutation key is also used the invention is even better protected. hacking a document would reveal a password but this password (h) is not directly related to the data transmitted by the invention (i) as the invention has only sent information on how to alter the previous password not the password itself. If the password is assumed to be 256 characters and on each transmission of a document an average 4 characters where changed and the choice of these characters were random then the hacker would require to crack on average of (256/4)ˆ2 or 4000 files to obtain data equivalent to the password. Even where a vast processing power enabled this providing the mutation codes are selected randomly by the time the hacker had decoded one transmission according to the invention the mutation would have altered significantly and randomly and the hack would not be a crack of the system even for that node pair. The pairing of each decode key is claimed as advantageous as if a node became questionable it may be discarded and this does not affect transmissions between other nodes.

FIG. 13 shows how a host may initiate secure communications with a node. The node (a) contacts (b) the host and declares its registration number (c). The host has a look up table defining the parameters for the first communication for that registration (d) and thus sends an encrypted message. Following this communication the host and node message each other a plurality of times (e) with the message mutating on each communication.

FIG. 14 shows how a host may be used by two nodes (a) to initiate the start of a communication sequence via the host (b) without a security limitations. Each node has a communication sequence with the host and one node requests initialization of a new start decode key with a second node via the host using this sequence. The host then sends a new decode and authentication key to both nodes (c) and the nodes may then communicate directly (d). On each communication between the nodes the decode key mutates and thus whilst the host may have access to the original decode key between the nodes it has no knowledge of how the key has mutated.

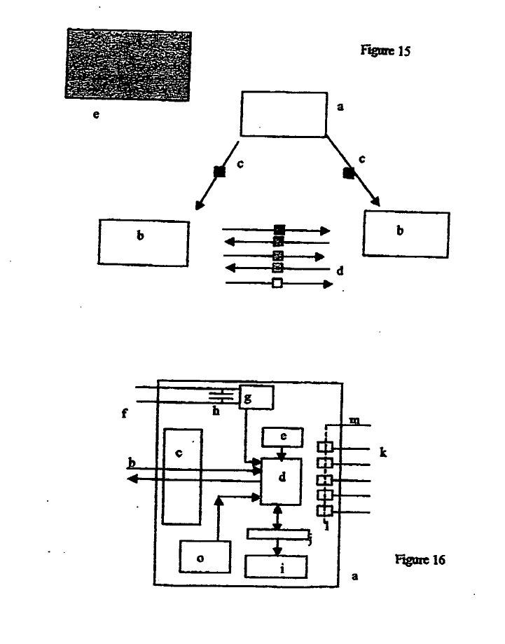

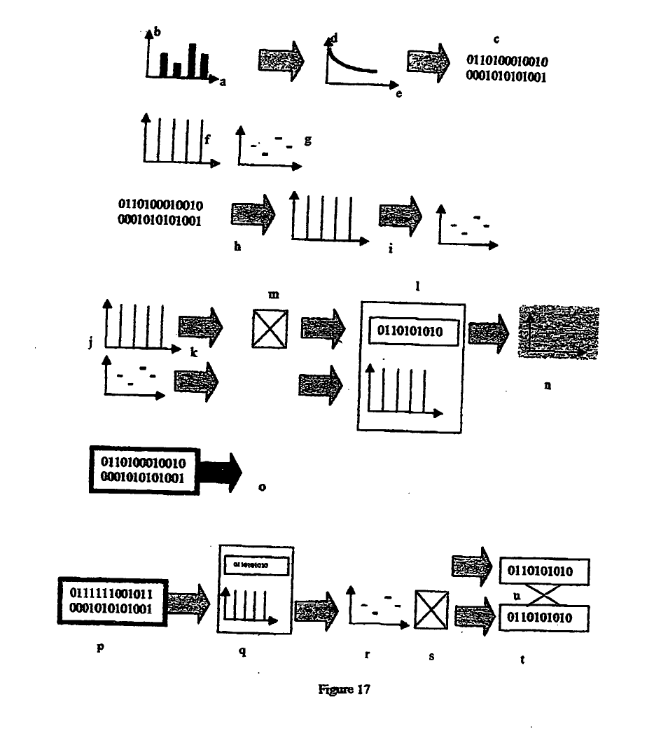

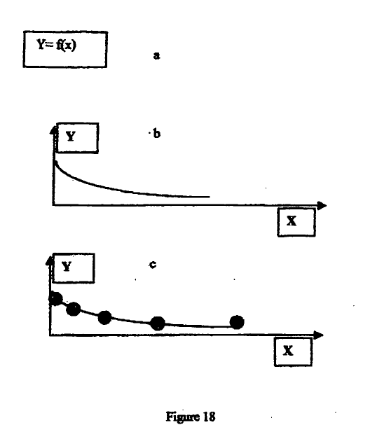

FIG. 15 illustrates how a node (a) may act as a host to initiate a start decode key between two further nodes (b) which are in communication with it. When requested by one or both nodes to provide a decode key it may facilitate one and send it to one or both nodes (c). As these nodes communicate the decode key becomes mutated (d) and the knowledge of the initial decode key rapidly becomes of limited use. The host (e) plays no part in the sequence. The method may be implemented in a manner that the user at the first node (a) has no input in generating the decode key and that the new decode key is not stored on the first nodes computer.

Each node has a list of all nodes it is has a decode with and the invention may include a protocol that defines when two nodes communicate they swop this information such that a network of nodes rapidly builds where any node can find multiple paths to start a decode sequence with any other node via a distributed network.

This provides a highly robust and secure network as loss of any particular node or host does not cause the system to fail. In addition the method cannot be attacked by distributed denial of service methods due to the distribution.

FIG. 16 shows a secure apparatus for encoding and decoding a signal. The apparatus consists on a single substrate (a) which encompasses all the parts. the substrate may be an electrical circuit, the substrate may be for an optional circuit the substrate may be for a hybrid circuit. The device includes a means of inputting and outputting data (b). The device may include a volatile memory area which may be a cache (c). The device may include a processor which performs encryption and decryption (d). The device may include read only memory which is only accessible to the processor and carries the operating instructions (e). The device may include a power supply (f), the power supply may have a check function which causes a stable shutdown of the device if power fails (g). The device may include a power store to ensure shut down is always properly complete (h). The device may include a re-writeable memory store to hold decode keys (i), the device may include encryption all or part of the keys when stored using conventional encryption means. The encryption may be hardwired (j). The encryption may include one way encryption. In many production techniques it in necessary to have test ports, one such test port is known in the art as JTAG. Test ports are known in the art as weaknesses to the security of the device. The device may have a test port (k). All or some of the testport inputs and outputs may pass through fuselinks (l) or other protection devices which may be deactivated (m) following final test at manufacture. The device may include a random number generator (o) preferably the random number generator is not deterministic.

FIG. 17 shows implementation of one way encryption to protect the stored authentication keys between transmissions. Mathematical functions are selected to produce a encryption algorithm. In this example a mixture of exponentials of differing decay values (a) and weightings (b) are used. This encryption algorithm can be used to produce a data stream (c) by calculating magnitudes (d) for a series of ordinate value (e) for a set of parameter values. The parameters may be separated into decode key and an authentication key. In this example the decode key is defined as the decay values of each exponential (f) and the authentication sequence is the relative magnitude of each decay (g).

The produced data stream may then be checked that it can be decrypted. When the decode key is applied (h) the authentication signal found (i) should match that previously defined. If this does not occur steps a-i are repeated until the code can be decrypted.

The decode key ad authentication information must then be stored until a message is received from the second node.

This storage is normally a weak point as the keys must be held in memory and it is therefore subject to attacks on the hardware system. This is over come as the decode and authentication keys (j) are transferred separately (k) to the memory area (l) and the authentication key is one-way encoded (m). A one way encoding system is a system where a given string of characters will always encode to the same sequence but where no decode algorithm exists or are supplied. After decoding, the memory area that the authentication keys were produced and held in, is flushed with random data. the data file may now be read out of the authentication apparatus and be sent or stored on unsecure medium (o). The generating node does not have the required information to check that the message it just sent was authentic and the system is protected from hardware intrusions.

On receipt of a new message (p) the apparatus constrains the decryption (q) according to the decoding key and obtains the authentication key of the received signal (r). The user cannot check the received authentication key directly and must first one-way encrypt the signal (s) and compare the received one way encrypted authentication key with the stored one way encrypted authentication key.

This example has ignored mutation keys and other carried information for charity but this does not limit use of the invention to carry more information that given in this example.

FIG. 18 shows the formation of a data stream using one or more mathematical functions to produce an encryption means. The encryption algorithm (a) produces a data stream by calculating an output value for each ordinate (b). The ordinates need not be linearly spaced (c) and the ordinates are not transmitted in the data file and form a part of the encryption algorithm.

This would hinder any decryption using conventional signal processing techniques which include but are not limited to correlation and Fourier transforms.

One or more of the parameters of the encryption means may modify the ordinate spacing used to provide the magnitudes used in the data stream. By way of example the spacing may be due to a linear function such as X=N^{P} where X is the ordinate value and P is a parameter value and N is defines the Nth ordinate. For P=1.1 we have the sequence 1, 2.14, 3.48, 4.59 . . . . Only the magnitudes are used in data stream such that without the knowledge of P, and the equation, the data stream cannot be plotted in a manner that allows conventional signal analysis to deconvolute the signals. The equation gives only one simple example of the use of altering the ordinate spacing and any equation may be used. The spacing may vary in a non-linear or random from defined by the decode key. The spacing may not be present in the decode key directly but the parameters may be acted on by a mutation key. The form of the equation used to produce the ordinates as well as its parameters may be mutated by an encryption algorithm parameter.

FIG. 19 defines a method of sandwiching conventional encryption means with the encryption means according to this invention. The parameters (a) are thus defined by the user as previously described and then the parameter list is encrypted (b) by a second encryption means known in the art (c). the encrypted parameter file is then used to produce a data stream file (d) using the encryption algorithm (e).

The data stream file may then be added to a larger file or package with any document or other file that requires to be sent with the signal produced by the invention. The larger file may be compressed (f). The larger file is known as a zip file or tarball in the art. The tarball may then be encrypted by a third encryption means known in the art (g). The second and third encryption means by the mutated by parameters in the encryption algorithm according to the invention. The passwords may mutated or the type of conventional encryption may be mutated or both may be mutated.

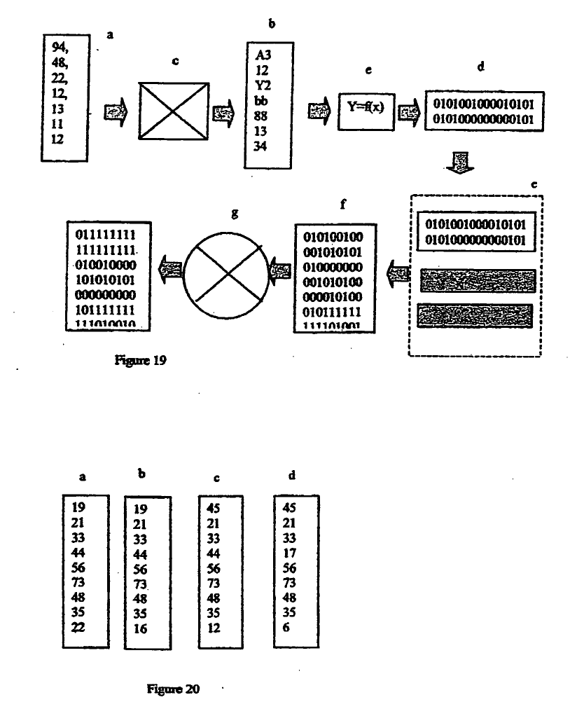

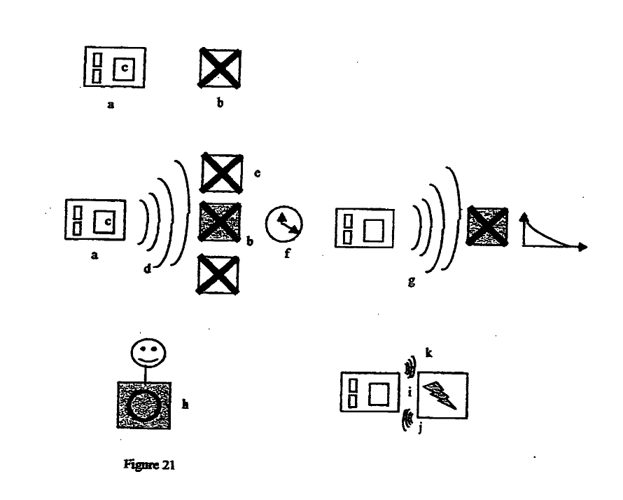

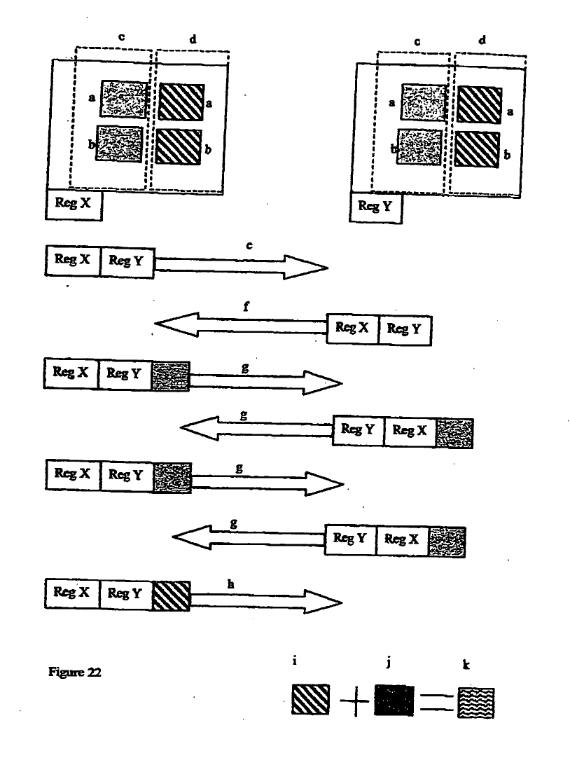

FIG. 20 shows that the encryption of the parameter file gives added benefit over either encryption mechanism alone as where the parameters are predominantly used for authentication codes the parameters vary only a small amount on each transmission due to the mutation code. Parameter codes are shown for four subsequent transmissions (a, b, c, d) where the final parameter is the mutation code and other parameters are authentication codes. Whilst is parameter list and thus data stream differs they have a similarity and similarity is a weakness of encryption. Where conventional encryption is used on the parameter file there will be no ore reduced similarity in the parameters thus each data stream should vary randomly giving added advantage. The encryption may be done by means of a look up table. The encryption may be programmable by the mutation codes.

FIG. 21 shows an implementation of the invention applied to a car security system. The system comprises a fob (a) and a security system (b). The fob and the security system act as nodes and have their own registration number. When the unlock button is pressed (c) the fob sends out a signal (d) which includes the fobs and the cars registration number and this activates the corrects car security system (b) whilst other car security systems ignore the command (e). The signal may be sent by any means. The security system may include timers and protocols (f) ensuring that there is a limited time and a limited number of attempts the fob may make to activate the system using a data stream.

The fob then sends a (g) data stream according to its encryption algorithm which the security decodes according to a decode key and then one way encrypts and compares with the stored one way encrypted authentication key it has for the registration number of the fob. If correct the vehicle is unlocked (h). If incorrect a security protocol is followed. The security protocol may allow a number of resends providing the data streams are similar (not random guesses) to allow for signal dropout.

When the key is placed in the ignition (i) the car sends a data stream to the fob (j) and the fob responds (k) activating the car.

When the key is removed from the car the car reprograms the key for next usage and oneway encrypts the authentication key before storing it.

If the fob is lost the owner procures a new fob and programs it to open the car (car registration code). The car notes that a new fob has requested access and contacts the manufacturer of the car, or his agent. The car states its registration number and that of the new fob and the manufacture contacts the car directly by means of the invention using his IP address and a decode key handwritten into the car and new fob on manufacture. The manufacture knows the decode or the new fob and can thus act as a node and initiate start up between the fob and the car.

The user may also contact a manufacturer if he has multiple security devices and wishes to have one fob code many security device.

That allows fobs to be distributed on an insecure supply chain as they are of no use until authorised for a particular vehicle by the manufacture and thus have advantage over conventional keys.

The vehicle may be programmed only to accept the registration of a particular fob for a specific time, allowing the method to be used for hire vehicles for example hire cars. Since the fob is a re-programmable node, this allows the fob to be programmed for an extended period by unsecure communications by the fob owner and thus rental time to be increased by any communication means attached to the fob.

Whilst the implementation has been described for use of access to a vehicle it is to be appreciated it may be used a variety of other applications with the benefit that the door or effective door has no direct knowledge of the key that fits as this information is one way encoded.

FIG. 22 shows a double handshake implementation that ensures both parties are authenticated and use of a nested method to add to security. FIG. 22 shows two nodes defines as registration number X and Registration number Y. FIG. 22 assumes the more complex situation where it is X's turn to send data but the X is requesting communication. Each node has an area of one way protected memory (a) and an area of uncoded memory (b) holding the necessary keys. In addition this occurs twice with an authentication set of parameters (c) and a password exchange set of parameters (d) as the method is shown in nested mode.

X contacts Y by a means that may be unencrypted and requests contact according to the invention (e). Y responds but as it is X's turn to send data so the reply is simply acknowledgement (f). Reg X then initiates the dual handshake (g). the parameters for this contain no information other than mutation keys, authentication keys and thus an open text attack has no text to use as a model.

After the double handshake both parties can authenticate who they are in contact with and X can send a message using the second encryption algorithm (d) according to the invention which allows information relating to a password to be carried.

This ensures that useful information is never sent until after users have authenticated each other and minimises the number of transmissions where information is present in encrypted signals limiting data harvesting by a hacker.

FIG. 22 illustrates that the message (i) may not carry the password but a mutation code which when applied to an existing password (j) allows a new password to be formed (k). This ensures that the password itself is never itself included and further limits open text attacks.

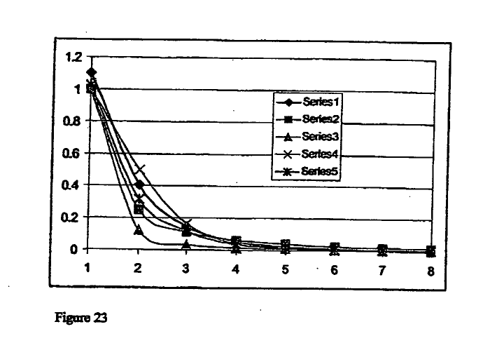

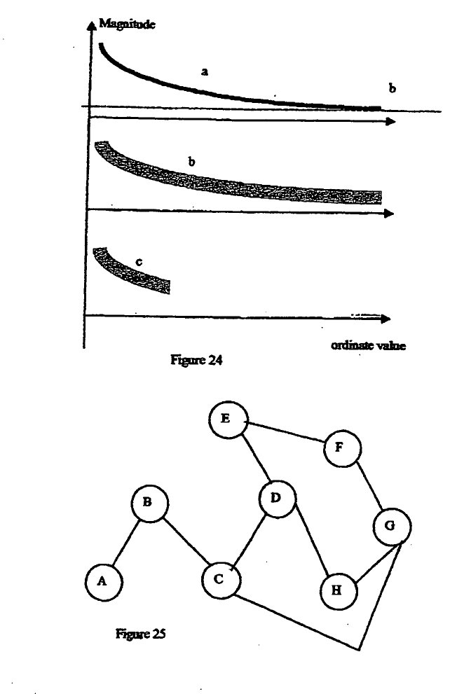

FIG. 23 gives an example of a few of the multitude of mathematical functions that may be used in the invention where Series 1=3/exp (x), series 2=1/x², series 3=1/x³, series 4=1/x! and series 5=sum of above/4.

FIG. 24 shows how use of a baseline offset may be used to provide a secure means. This example shows an exponential like function but it is claimed that all functions may be given a baseline offset. The trace shows the output of an encryption algorithm (a) accurately represented with a baseline offset (b). When the accuracy of representation is reduced by the inclusion of noise (c) the exact measure of the baseline becomes difficult and if the data set is clipped such that the data used in the data stream does not include the baseline. It is claimed that using this method the value of the baseline may be used as a decode parameter enabling accurate decoding but without this decode parameter analysis by a hacker is limited as without a baseline hacking methods are liable to be unstable and more time consuming.

FIG. 25 represents a map of nodes to allow a distributed network to produce start up decodes between nodes. The map shows interconnection between nodes A-H. By way of example if C wishes to start decode key to F there are a plurality of pathways CGF, CDEF, CDHGF, CGHDEF. In simple map terms CGF may be shortest communication but the map may exist on multiple levels and CDEF may be the route that has the most bandwidth available and CDHGF may te route of shortest average hop distance and thus lowest power if wireless communication are used.

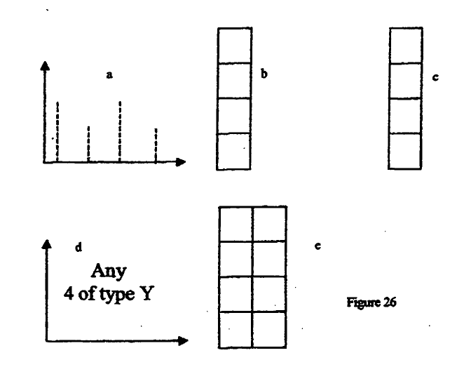

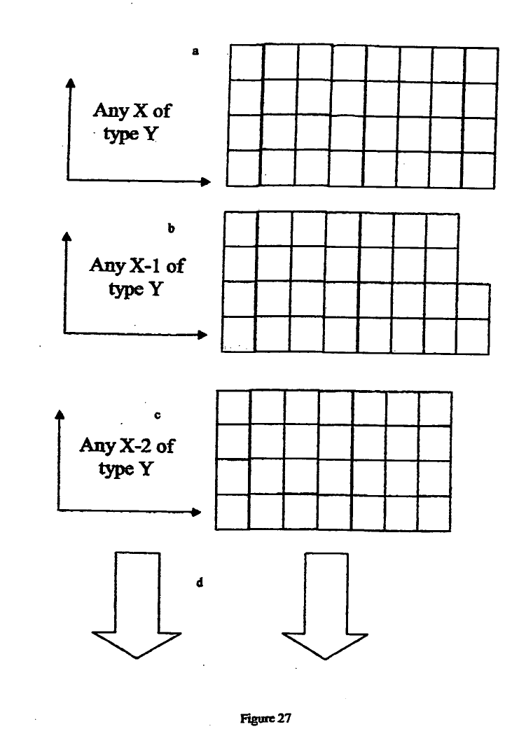

FIG. 26 shows that to try a guessed value of password takes considerably longer than to apply the correct password.

Even where the hacker knows the correct number of mathematical functions used in the encryption and the type of mathematical functions used in the encryption the hacker has more parameters that must be iterated and thus each guess takes longer. (a shows a four exponential code where the decay times are used as a decode key (b) and the magnitudes as the authentication key (c) such that a correct node user has 4 unknown parameters to decode. The hacker has at least eight unknown parameters to float in the fit (e) even assuming ordinate and baseline parameters are not used. Time taken to carry out a decryption fit increases non-linearly with parameter number and so modest number of parameters may be decoded in 60 seconds on a desktop PC but to calculate the goodness of fit of a single guess may take over 15 minutes on the same computer.

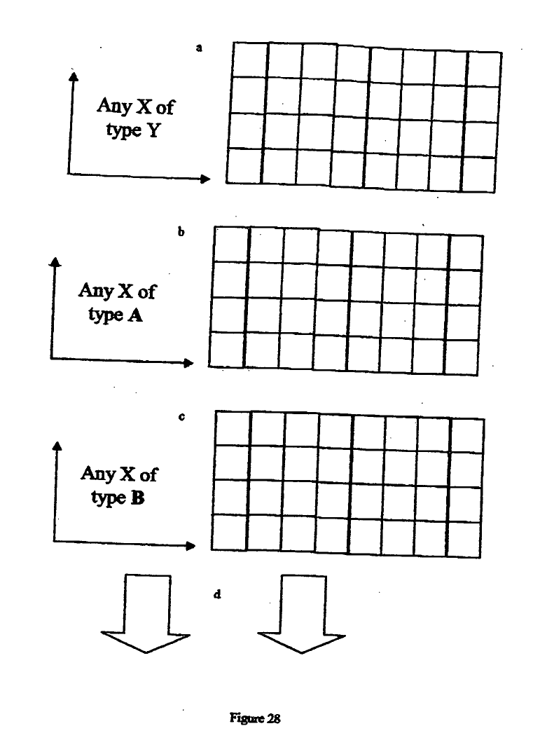

FIG. 27 shows the situation where the hacker has no information of the number of mathematical functions but is aware of the type used. The hacker must initially assume the maximum practical numbers of mathematical functions that could be present (a) and then slowly reduce this number in each fit (b, c, d,) to attempt to calculate which answers are the most probable. The non-linear nature of the time taken to fit with respect to the number of parameters may take this approach of hacking unsuited to anything nut the largest of computers. Using a the same processor as that which could decode using the correct key in 60 seconds the analysis to find the list of ‘probable’ answers could take in excess of 1 week for even quite simple encryption's according to the invention

FIG. 28 illustrates the situation where the hacker is unaware of both the number and the form of the mathematical functions that have been used in the encryption algorithm. Now the hacker must analyse for practical mathematical functions (a, b, c) using the at least th maximum number of parameters that could be used in the decode key. For each function type considered the hacker must then stepwise reduce the parameter number as FIG. 27. The time taken to carry out the analysis as well as the number of probable answers found grows as a power function. It is claimed that using a coding according to the invention can thus produce a problem for the hacker that is of vast mathematical complexity even for supercomputers, parallel computers or distributed networks of computers and thus produce a secure means of encryption.

It is advantageous in security that a guessing of a key takes considerably longer than decoding with a key using similar processing means.

it is advantageous that it takes longer to guess the value of the key than to input the correct value and allows smaller passwords to be used.

Further details of the invention are provided in the Appendix, which describes many aspects of the invention and provides specific examples of how to encode and decode information using the methods and apparatus of the invention.

The embodiments and different aspects of the invention contain many features, which may be used in other embodiments and aspects of the invention.

It is to be appreciated that the embodiments of the invention described above with reference to the accompanying drawings have been given by way of example only and that modifications and additional components may be provided to enhance the performance of the apparatus.

It is to be appreciated that a transmitter may be taken to mean any part of a system that transfers data from the system and a receiver may be taken to mean any part of a system that collects data from outside the system. The data may be output or read or in on any media and may occur by means of electrical, magnetic, optical, sonic or other means. For the purpose of this invention a punch card writer or ticker tape writer may be termed a transmitter. It is to be appreciated that a parameter may carry multiple pieces of information if a coding is used and thus a parameter may act as both a authentication parameter and a mutation parameter and a password parameter.

The present invention extends to the above mentioned features taken singularly or in any combination. Thus, for example, steps (c) and (d) herein can be effected in the reverse order.

1. A method for encoding and decoding information, the method comprising the steps of:
a) using at least one mathematical function;
b) producing an encryption algorithm using the mathematical functions such that the algorithm has at least two parameters;
c) defining a decode key of a data stream by defining the value of at least one parameter;
d) defining information to be carried in a data stream by defining the value of at least one parameters;
e) producing a data stream using the encryption algorithm and the defined parameter values; and
f) decrypting the data stream where the decode key is known and used as a constraint in the equation such that the information is available,
wherein the encryption algorithm is selected such that decoding of the encryption algorithm would be ill-conditioned without the constraint.

2. A method according to claim 1 where at least one of the mathematical functions used in the encryption algorithm is selected to be a non-periodic function.

3. A method according to claim 1 where the information includes an authentication key, and including the step of validating the authentication key.

4. A method according to claim 1 where information includes at least one mutation key, and including the step of using the mutation key to effect at least one of the next data stream created or received, the form of ordinate spacing used in the encryption algorithm, the weighting of at least one of the mathematical functions used in the encryption algorithm, the number of mathematical functions used in the encryption algorithm is effected by a mutation key, and at least the type of mathematical functions used in the encryption algorithm.

5-8. (canceled)

9. A method of claim 1 and including the step of limiting the accuracy of the representation of the data stream by using at least truncation of the values of the data stream.

10-14. (canceled)

15. A method according to claim 1 and including the step of the data stream producer decrypting the produced data stream and where decryption fails modifies the value of sat least one parameter used to produce said data stream and produces a second data stream and continues the process until a data stream that correctly decrypts has been produced and discards all data streams that could not be decrypted.

16. A method according to claim 15 where the parameters that are altered to allow a data stream that can be decrypted includes at least one mutation parameters.

17-19. (canceled)

20. A method according to claim 1 and including the step of allowing a user to select a value and influence the probability that produced data streams cannot be decrypted.

21-22. (canceled)

23. A method according to claim 1 where at least one of the parameters of the encryption algorithm carries information that may be defined as a password of an external system.

24-26. (canceled)

27. A method according to claim 1 where the storage area used to hold at least some of the parameter values that form an authentication key is within the same substrate as the processor which encrypts the messages.

28. A method according to claim 1 which includes the step of including a means to immediately overwrite or flush a temporary data store used in coding or decoding of a data stream.

29. A method according to claim 1 and including the step of encrypting the produced data stream using conventional encryption means.

30. A method according to claim 1 and including the step of encrypting at least some of the information prior to it being used to define the values of parameters of the encryption algorithm.

31-32. (canceled)

33. A method according to claim 1 where authentication between users includes a double handshake protocol.

34. A method according to claim 1 that includes the step of issuing a unique registration number to each node.

35-36. (canceled)

37. A method according to claim 1 and including the step of using a protocol such that a first node who is on contact with both a second and third node may act as a start up host between the second and the third node without a host and so provide a distributed start up means.

38. A method according to claim 1 and including the step of having a plurality of stored starting decode keys between node pairs on each node such that on a communication failure reconnection may occur rapidly.

39. A method according to claim 1 in which the method is used in nested mode such that a first encryption algorithm is used to authenticate between users and then a second encryption algorithm is used to transfer useful information.

40. A method according to claim 1 where the information stored includes that of tokens of value that become the property of the owner of the registration number due to a purchase made by means of the invention where the tokens may be exchanged for further goods or services.

41. (canceled)

42. Apparatus comprising transmitting means receiving means, processing means and operating instructions allowing decryption of a signal according to the method of claim 1.

43. (canceled)
